(19) United States
(12) Patent Application Publication
(10) Pub. No.: US 2014/0078542 A1
(43) Pub. Date: Mar. 20, 2014

(54) PRINT CONTROL APPARATUS AND PRINT CONTROL METHOD

(71) Applicant: CANON KABUSHIKI KAISHA, Tokyo (JP)

(72) Inventor: Michihei Murayama, Tachikawa-shi (JP)

(73) Assignee: CANON KABUSHIKI KAISHA, Tokyo (JP)

(21) Appl. No.: 14/023,301

(22) Filed: Sep. 10, 2013

(30) Foreign Application Priority Data
Sep. 14, 2012 (JP) 2012-203091

(51) Int. Cl. G06K 15/00; H04N 1/00

(52) U.S. Cl. CPC G06K 15/4095; H04N 1/00856
USPC 358/1.14

(57) ABSTRACT

To prevent printing of a print content based on a print request from an unauthorized requestor, information for identifying a requestor who has made a print request for printing a print content is received, notification of the requestor is provided based on the received information, designation is made whether to permit the printing based on the print request from the requestor, and determination of whether to perform the printing based on the print request from the requestor is made in accordance with the designation.

### BACKGROUND

1. Field

Aspects of the present invention generally relate to a print control apparatus and a print control method for printing a print content.

2. Description of the Related Art

A technique has been known, in which a printer that a user who is to be an issuer of a print job is permitted to use is registered and the user specifies the registered printer for execution of printing (see, e.g., Japanese Patent Laid-Open No. 2012-133728). In the technique disclosed in Japanese Patent Laid-Open No. 2012-133728, the user name of a user who can access the printer is registered. The user selects a desired printer from a list of available printers displayed on his/her terminal and causes the selected printer to execute printing.

When available printers are registered for each user, the user can continue to use the printers unless the registration is cancelled. Therefore, for example, even when an owner or administrator of a printer changes or the installation location of the printer is changed, the user may select the printer by mistake. From the printer's perspective, a recording material, such as ink or toner, and a recording medium, such as a sheet of paper, may be wasted on unnecessary printing. Additionally, since an image printed on a recording medium does not indicate who has given an instruction to print the image, printing of a print job from the same source may be repeated.

### SUMMARY OF THE INVENTION

According to an aspect of the present invention, an apparatus includes a receiving unit configured to receive information for identifying a requestor who has made a print request for printing a print content, a notifying unit configured to provide notification of the requestor based on the information received by the receiving unit, a designating unit configured to designate whether to permit the printing based on the print request from the requestor, and a determining unit configured to determine whether to perform the printing based on the print request from the requestor in accordance with the designation made by the designating unit.

Further features of the present disclosure will become apparent from the following description of exemplary embodiments with reference to the attached drawings.

### BRIEF DESCRIPTION OF THE DRAWINGS

FIG. 1 is a block diagram illustrating a configuration of a printer according to an embodiment.

FIG. 2 illustrates a configuration of a network system.

FIG. 3 illustrates a configuration of a network system according to an embodiment.

FIG. 4 illustrates a cover page to be printed.

FIG. 5 illustrates a screen for entering account information from which printing is to be rejected.

FIG. 6 illustrates a flow of processing a print job.

FIG. 7 illustrates a flow of processing a print job.

FIG. 8 illustrates a flow of setting rejection of printing.

FIG. 9 illustrates a flow of rejection of printing.

### DESCRIPTION OF THE EMBODIMENTS

The following embodiment(s) will be described in detail with reference to the attached drawings. Note that the following embodiment(s) are not intended to be limiting, and not all combinations of features described in the embodiments are essential for the provided solution.

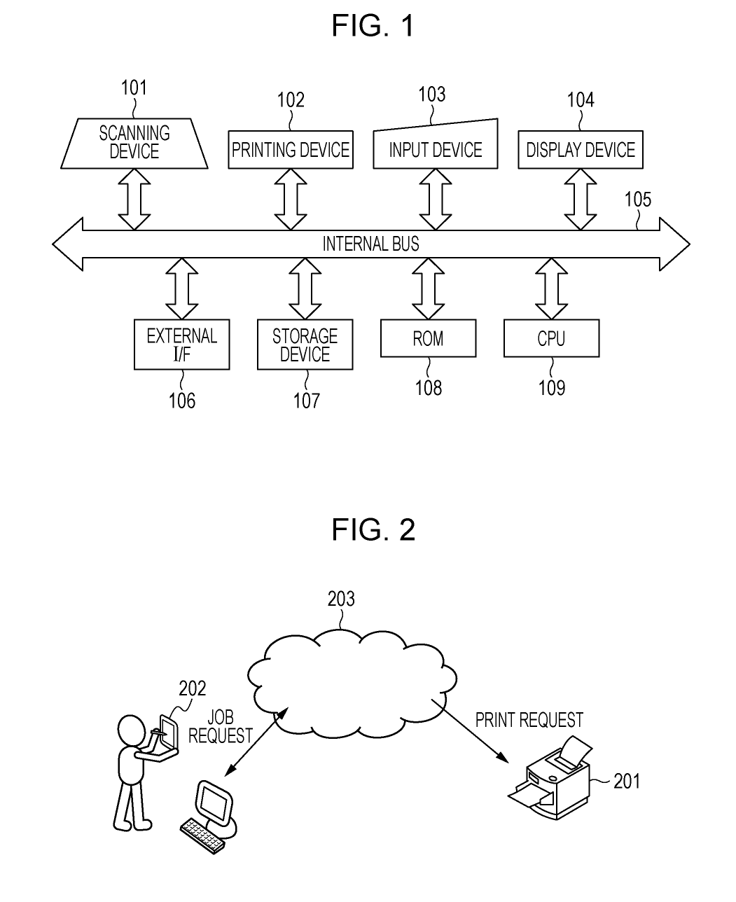

FIG. 1 is a block diagram illustrating a configuration of a printer that is a print control apparatus in a present embodiment. In the present embodiment, a multifunction printer (MFP) having an image reading function will be described as an example of the printer.

A scanning device 101 reads an image on a set document and generates image data representing the read image. A printing device 102 prints an image by applying a recording material, such as ink or toner, onto a recording medium, such as a sheet of paper, based on the input image data. An input device 103 receives various operations from a user for giving instructions to the printer. A display device 104 displays various types of information to be provided to the user. The input device 103 and the display device 104 may be combined together to form, for example, a touch panel.

An external interface (I/F) 106 is an interface for connecting the printer to a network or an external device. A storage device 107 stores image data and information necessary for operating the printer, or is used as a work area for a central processing unit (CPU) 109. A read-only memory (ROM) 108 stores programs necessary for the CPU 109 to control the printer. The CPU 109 controls an overall operation of the printer. The components described above are connected and can communicate with each other via an internal bus 105.

FIG. 2 illustrates a network system to which the printer of FIG. 1 is connected.

Reference numeral 201 denotes the printer illustrated in FIG. 1. The printer 201 is connected via the external I/F 106 to a network 203. The connection to the network 203 may be either a wired connection or a wireless connection.

A user 202 uses a terminal, such as a mobile terminal or a personal computer (PC), to acquire, via the network 203, information about printers associated with the user 202 or with the terminal used by the user 202. The user 202 selects the printer 201 from the associated printers, and makes a request for execution of a print job via the network 203. Thus, a print request is sent to the printer 201, which receives print data for the print job issued by the user 202 and executes printing of an image based on the received print data.

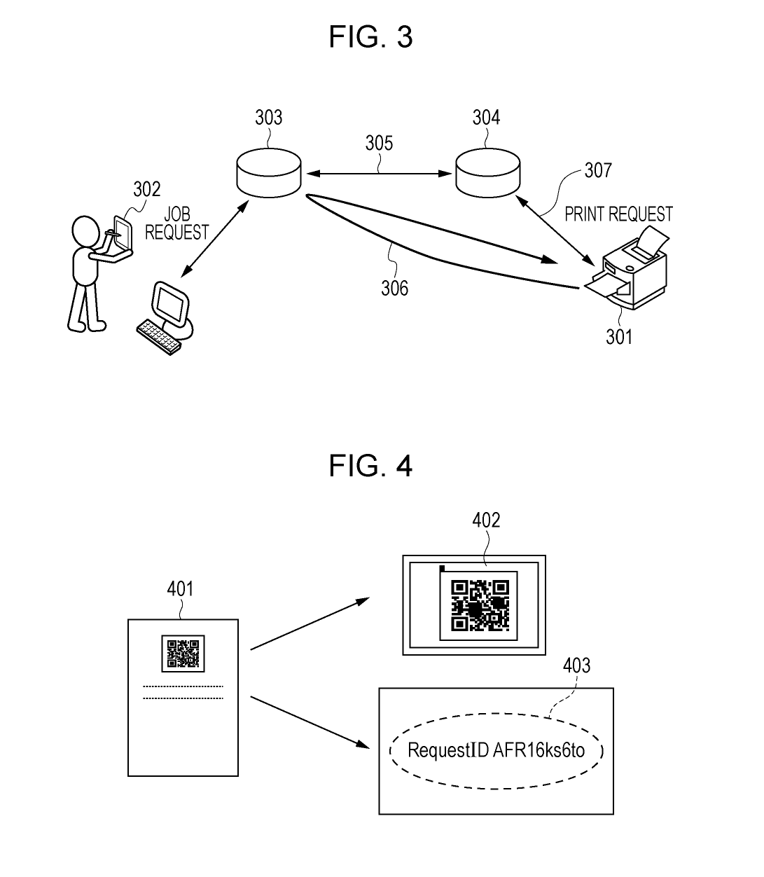

FIG. 3 illustrates a network system for describing details of processing performed within the network 203 illustrated in FIG. 2. A printer 301 and a user 302 illustrated in FIG. 3 correspond to the printer 201 and the user 202, respectively, illustrated in FIG. 2.

A portal server 303 manages services provided to users. The configuration of the portal server 303 is similar to that of printer 201 illustrated in FIG. 1, but does not include the scanning device 101 or the printing device 102. The portal server 303 manages each account information for identifying a user, and available services and printers associated with the account information. Examples of the account information that can be used include a user name, a user ID, a name of a terminal the user uses, and a user's email address. The portal server 303 has a web server function, which allows users to use, via a general-purpose browser, information and available services managed by the portal server 303.

The user 302 logs in with the user's account using a general-purpose browser installed in the terminal, and uses services available to the user 302. When the user 302 uses the terminal to request a print job to be printed by the printer 301, the portal server 303 issues a print request 305 for printing by the printer 301. The print request 305 includes account information representing an issuer of the print job, a location of a print content (i.e., a uniform resource locator (URL) indicating a location where the print content is stored), and a name of the printer requested to print. The portal server 303 stores the print content (print data) to be printed.

A printer management server 304 manages a plurality of printers including the printer 301. The configuration of the printer management server 304 is similar to that of printer 201 illustrated in FIG. 1, but does not include the scanning device 101 or the printing device 102. When the print request 305 for printing by the printer 301 is received from the portal server 303, the printer management server 304 transmits to the printer 301 a print request 307 accompanied by information indicating the location of the print content to be printed. Before transmitting the print request 307, the printer management server 304 checks whether the destination printer (printer 301) is a printer available to the user identified by the account information included in the print request 305. If it is confirmed that the printer 301 is available to the user, the printer management server 304 transmits the print request 307 to the printer 301. Also before transmitting the print request 307, the printer management server 304 checks whether the printer 301 is ready for receiving the print request 307. If it is confirmed that the printer 301 is ready for receiving the print request 307, the printer management server 304 transmits the print request 307 to the printer 301. The printer management server 304 is associated with the printer 301. When the printer 301 is specified, the portal server 303 identifies the printer management server 304 associated with the printer 301, and transmits a print request to the printer management server 304. The printer management server 304 can serve as a print control apparatus which is capable of identifying the account of the user who has made the print request and controlling whether to permit printing depending on the identified account.

Upon receipt of the print request 307, the printer 301 acquires the print content from the portal server 303 in accordance with the information indicating the location of the print content, the information accompanying the print request 307 (in 306 of FIG. 3). Then, the printer 301 prints the print content on a recording medium. Note that instead of automatically printing an image of the print content upon receipt of the print request 307, the printer 301 first prints information that identifies the user who is an issuer of the print job. Then, the printer 301 may print the print content when an operation that permits printing of the print content is done by a user of the printer 301.

The system illustrated in FIG. 3 is only an example, and the printer management server 304 may be omitted, so that the printer 301 acquires a print request from the portal server 303. Alternatively, the printer management server 304 may acquire a print content from the portal server 303, so that the printer 301 acquires the print content from the printer management server 304 and prints the acquired print content in accordance with a print request.

FIG. 4 illustrates a cover page for identifying, before the printer illustrated in FIG. 1 executes a print job (i.e., prints a print content) in response to a request from a user corresponding to account information, a print requestor (e.g., account information) who requests printing of the print job. The printer illustrated in FIG. 1 prints the cover page when a cover-page print mode for printing a cover page is set. The cover page is not printed when the cover-page print mode of the printer is cancelled or when a print request is from a source (requestor) registered such that printing of a print content therefrom is not rejected. A printer management server may manage whether to execute the cover-page print mode. Alternatively, the printer management server may refer to the printer to check whether the cover-page print mode is set in the printer, and determine whether to cause the printer to print the cover page depending on whether the cover-page print mode is set.

Referring to FIG. 4, a cover page 401 includes a symbol 402 obtained by turning account information that represents a print requestor into a QR code (registered trademark), and a character string 403 describing the account information. In accordance with the printed cover page 401 including the symbol 402 and the character string 403, a user of the printer determines whether to reject printing of a print content. If the user determines that printing of the print content is to be rejected, the user uses the input device 103 to input the account information written in the cover page 401, or causes the scanning device 101 to read the symbol 402 so as to input the account information. This makes it possible to reject printing of the print content. This account information is registered in the storage device 107 as an account from which printing of a print content is to be rejected. On the other hand, if printing of the print content is to be permitted, the user inputs the account information from the input device 103 or the scanning device 101 (i.e., by reading the symbol 402) as an account from which printing is to be permitted, and executes printing of the print content. This account information is registered in the storage device 107 as an account from which printing of a print content is to be permitted.

When printing of a print content is to be permitted, the account information may not be input and the print content may be printed automatically if, after printing of the cover page 401, account information from which printing is to be rejected is not input for a predetermined period of time. For account information which is registered once for permission or rejection of printing of a print content after printing of the cover page 401, the print content may be acquired and printed automatically from the next time without printing the cover page 401. When a print job is registered from a print requestor represented by account information which is not registered for permission or rejection of printing of a print content, the print content may be printed together with the cover page 401. In this case, in accordance with the printed cover page 401, registration may be made as to whether to permit printing of a print content from the account information, so that the subsequent print job is processed in accordance with the registration.

Although the symbol 402 and the character string 403 are written in the cover page 401 in the example illustrated in FIG. 4, only one of the symbol 402 and the character string 403 may be written in the cover page 401. The symbol 402 does not have to be a QR code (registered trademark), and the character string 403 does not have to be written in the manner illustrated in FIG. 4. To enable the user to view the summary of the print content, a reduced image or a part of the print content may be included in the cover page 401.

As described above, it is possible to designate whether to permit printing based on a print request from an account which is identified by causing the cover page 401 to be read.

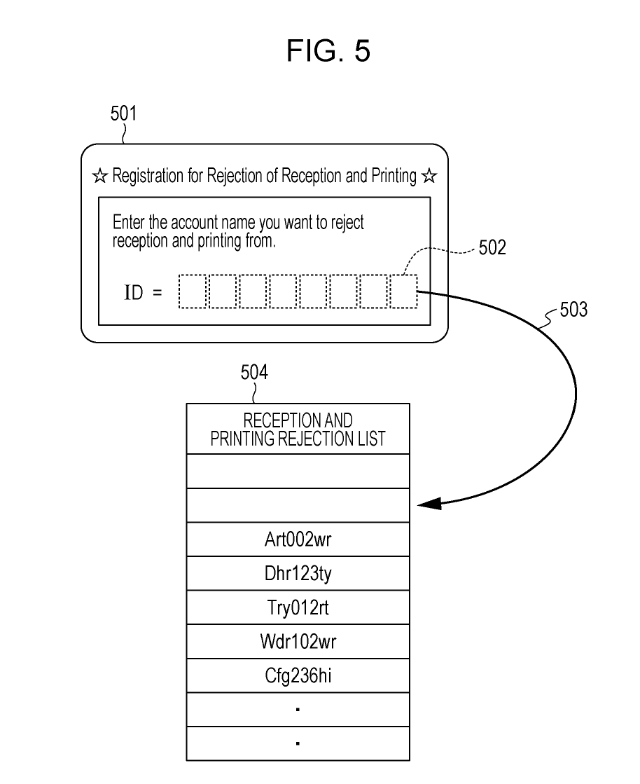

FIG. 5 illustrates a screen for entering account information of a print requestor from which printing of a print content is to be rejected.

The user operates the input device 103 to display, on the display device 104, a screen 501 for registering information of an account from which printing of a print content is to be rejected. Then, the user uses the input device 103 to enter, in an account-information entry field 502, information of an account from which the user wants to reject printing of a print content. Thus, the account information entered here is registered on a reception and printing rejection list 504 in the storage device 107 (in 503 of FIG. 5), and the printer management server 304 is notified of the registered account information. From this point onward, the printer management server 304 does not transmit, to the printer 301, the print content of any print job from this account information. Thus, since no print content is received, the printer 301 does not print any print content from this account information.

For entry of information of an account from which printing of a print content is to be permitted, the user similarly displays, on the display device 104, a screen for entering an account from which reception and printing is to be permitted, and uses the input device 103 to enter such account information. Alternatively, information of only an account from which printing of a print content is to be either rejected or permitted may be registered, and the other may not be registered. In this case, when information of only an account from which printing is to be rejected is registered, printing from an unregistered account is permitted. Conversely, when information of only an account from which printing is to be permitted is registered, printing from an unregistered account is rejected, and thus printing from all accounts except that from registered accounts can be rejected.

When account information is registered, the following may be performed instead of printing the cover page 401. Specifically, when a print job is received, account information corresponding to the print job may be displayed on the display device 104, and whether to permit printing from the account information may be registered. Alternatively, a plurality of pieces of account information corresponding to a plurality of received print jobs may be stored in the storage device 107, and whether to permit printing from the account information may be registered later on. That is, the user may use the input device 103 to call the plurality of pieces of account information stored in the storage device 107 and display the called account information on the display device 104, and register whether to permit printing from each of the pieces of account information.

As described above, it is possible to designate whether to permit printing based on a print request from an account which is identified by input from the input device 103.

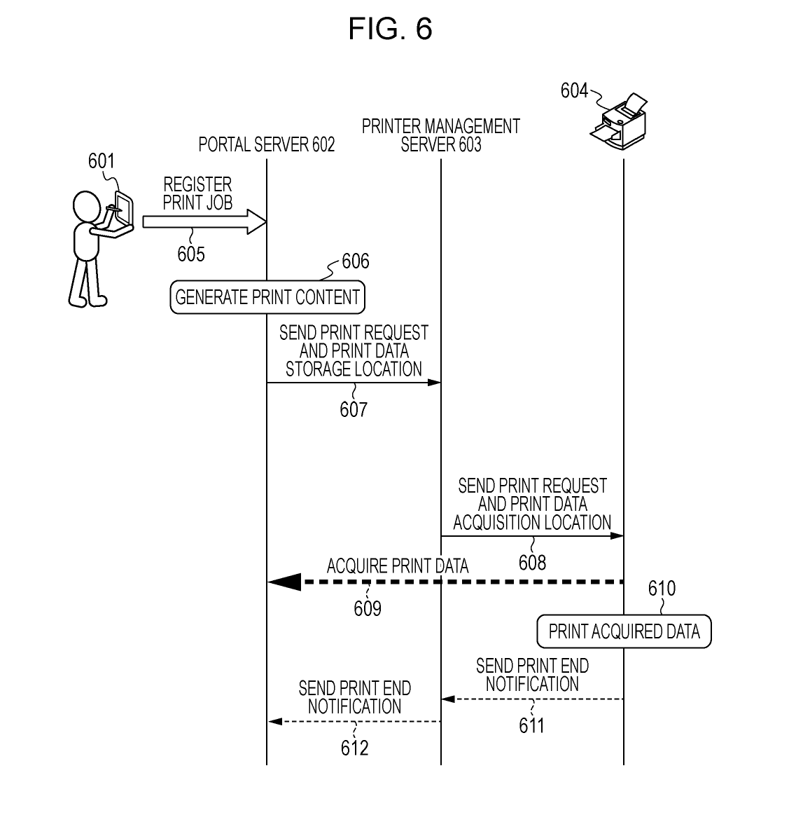

Next, a flow of processing a print job based on the foregoing configuration will be described. FIG. 6 illustrates a flow of printing a print job when the cover page 401 illustrated in FIG. 4 is not printed. That is, a flow of processing a print job in the network system of FIG. 3 is illustrated in FIG. 6. Note that “when the cover page 401 illustrated in FIG. 4 is not printed” mentioned above refers to the case where the cover-page print mode is cancelled in the printer management server or the printer, or to the case where a print request is from a source (requestor) registered such that printing of a print content therefrom is not rejected.

A terminal 601 is used by a user who is a print requestor. A CPU of the terminal 601 generates a print job in accordance with a program stored in a storage device of the terminal 601. Reference numeral 602 corresponds to the portal server 303 illustrated in FIG. 3. In accordance with a program stored in a storage device of the portal server 602, the portal server 602 executes the processing illustrated in FIG. 6 under the control of a CPU of the portal server 602. Reference numeral 603 corresponds to the printer management server 304 illustrated in FIG. 3. In accordance with a program stored in a storage device of the printer management server 603, the printer management server 603 executes the processing illustrated in FIG. 6 under the control of a CPU of the printer management server 603. Reference numeral 604 is the printer (printer 301) illustrated in FIG. 1. In accordance with a program stored in the ROM 108 or the storage device 107, the printer 604 executes the processing illustrated in FIG. 6.

The user of the terminal 601 logs into the portal server 602 with his/her account information using a browser installed in the terminal 601. Then, the user specifies print target data generated by the terminal 601 or data managed by the portal server 602 as a print target, specifies a printer to be used for printing, and registers a print job (in 605 of FIG. 6).

After the print job is registered, the portal server 602 generates a print content by converting the print target data into a predetermined format. Then, the portal server 602 associates the generated print content with the account information of the user who is a print requestor and information indicating the printer to be used, and manages the associated print content and information in a predetermined storage location in the storage device of the portal server 602 (in 606 of FIG. 6). Next, the portal server 602 notifies the printer management server 603 associated with the specified printer 604 of a print request for printing the print content (including the account information of the print requestor) and information indicating the storage location of the print content (in 607 of FIG. 6).

Upon receipt of the print request, the printer management server 603 checks whether the user corresponding to the account information included in the print request has the authority to use the specified printer 604, and whether the printer 604 is ready for printing. Additionally, the printer management server 603 checks whether the user corresponding to the account information included in the print request is registered such that printing therefrom is rejected. Then, if it is confirmed that the user has the authority to use the printer 604, the printer 604 is ready for printing, and the user is not registered for rejection of printing therefrom, the printer management server 603 notifies the printer 604 of the print request and the information indicating the storage location of the print content (i.e., a location where the printer 604 acquires print data) (in 608 of FIG. 6).

When the printer 604 receives the print request from the printer management server 603 and is ready for printing based on the print request, the printer 604 acquires the print content from the portal server 602 in accordance with the storage location information accompanying the print request (in 609 of FIG. 6). Then, in accordance with the acquired print content, the printer 604 prints an image on a recording medium. When the printing ends normally, the printer 604 transmits a print end notification to the printer management server 603 together with information (including the account information and the information indicating the printer 604) that identifies the print job (in 611 of FIG. 6). Upon receipt of the print end notification, the printer management server 603 transmits the print end notification to the portal server 602 together with information (including the account information and the information indicating the printer 604) that identifies the print job (in 612 of FIG. 6). Upon receipt of this, the portal server 602 associates the received information with the account information and stores the associated information with time and date information. This enables the user to view information about the print result when logging in with the user's account. If the printing does not end normally and ends in an error state, information indicating this is transmitted in 611 and 612 of FIG. 6.

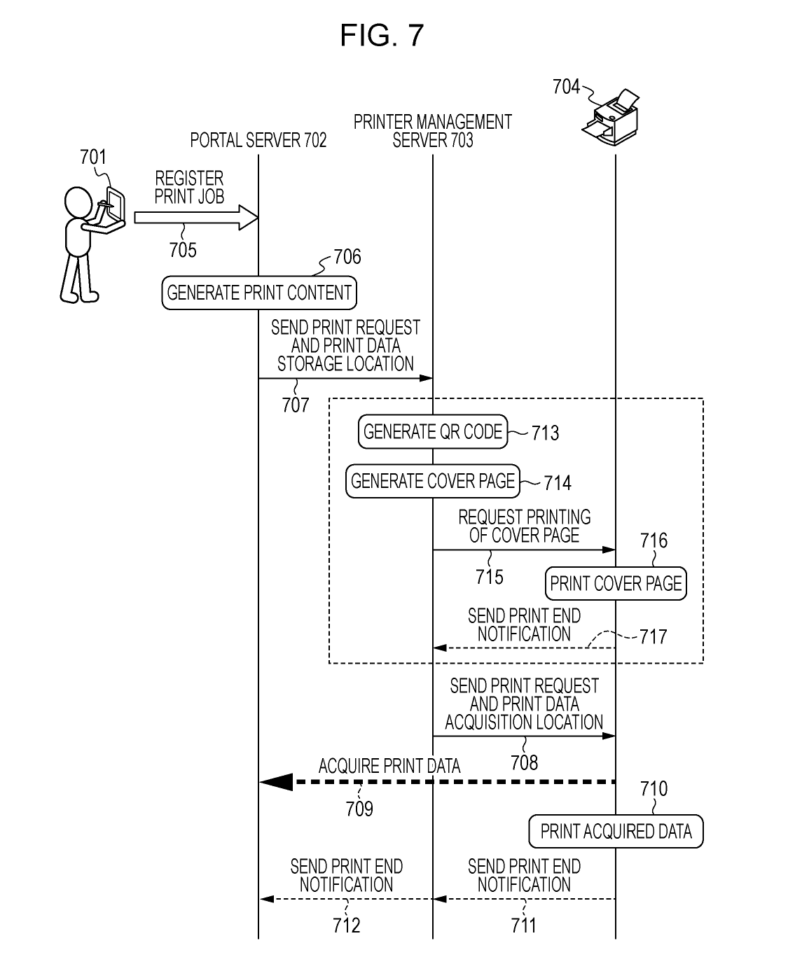

Next, a flow of printing a print job when the cover page 401 is printed will be described. FIG. 7 illustrates a flow of processing a print job, including a process for printing the cover page 401. Note that 701 to 712 in FIG. 7 are equivalent to 601 to 612 in FIG. 6 and will not be described here. Note, however, that after a print end notification indicating that the cover page 401 has been printed normally is sent in 717 of FIG. 7, a print request and location information indicating a location where the printer 704 acquires print data (i.e., a request from the printer 704 for the print request and the location information) are sent in 708 of FIG. 7 when the following condition is met. For example, the condition is that registration is made to permit printing of a print content, or registration for rejection of printing of the print content is not made for a predetermined period of time after printing of the cover page 401.

The process of 713 to 717 performed when the cover page 401 is printed will now be described. In 707 of FIG. 7, the printer management server 703 receives a print request and information indicating a storage location of print data via the portal server 702. Upon receipt of this, the printer management server 703 identifies a print request ID (character string) 403 including account information of a source of a print job (print requestor). Then, the printer management server 703 generates a QR code (registered trademark) (symbol) 402 representing the print request ID 403 (in 713 of FIG. 7). Next, the printer management server 703 generates print data representing the cover page 401 including the QR code (registered trademark) 402 and the print request ID 403 (in 714 of FIG. 7). Then, the printer management server 703 transmits a print request for printing the cover page 401 based on the generated print data to the printer 704 specified by the source (in 715 of FIG. 7).

Upon receipt of the print request including the print data of the cover page 401, the printer 704 applies a recording material, such as ink or toner, onto a recording medium, such as a sheet of paper, to print an image of the cover page 401 (in 716 of FIG. 7). If printing of the cover page 401 ends normally, the printer 704 transmits a normal end notification to the printer management server 703, whereas if printing of the cover page 401 ends abnormally, the printer 704 transmits an abnormal end notification to the printer management server 703 (in 717 of FIG. 7). After transmitting the normal end notification indicating that the printing of the cover page 401 has ended normally, if the condition described above is met, the printer 704 requests transmission of a print request corresponding to the print request ID 403 written in the cover page 401 and a print data acquisition location from the printer management server 703, and receives the print request and the print data acquisition location from the printer management server 703 (in 708 of FIG. 7). The print request and the print data acquisition location may be sent to the printer 704 when the printer management server 703 determines that the condition described above is met.

Note that the process of 713 to 717 is executed when the cover-page print mode is set in the printer management server 703 or the printer 704, and when the print request is from a source for which no information is registered as to whether to permit printing of a print content.

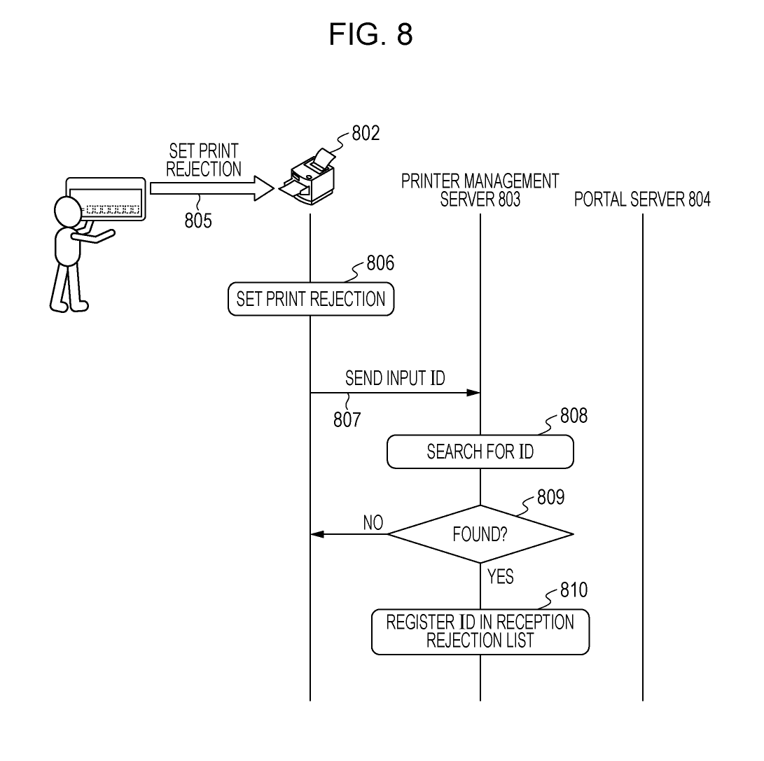

A flow of print rejection setting performed after printing of the cover page 401 will now be described with reference to FIG. 8. As in FIGS. 6 and 7, the flow to be described here is performed with the system configuration illustrated in FIG. 3.

First, from the input device 103, the user enters, on the screen of FIG. 5, account information of a source (requestor) from which the user wants to reject printing. Alternatively, the user causes the scanning device 101 to read the cover page 401 including a print request ID from a source (requestor) from which the user wants to reject printing (in 805 of FIG. 8). Thus, the CPU 109 of a printer 802 recognizes the account information of the source from which the user wants to reject printing, and stores the account information in the storage device 107 or the like as a user from which printing of a print content is to be rejected (in 806 of FIG. 8). Then, the printer 802 notifies a printer management server 803 of the account information input in 805 (in 807 of FIG. 8).

When the account information of the source from which the user wants to reject printing is received from the printer 802, the printer management server 803 searches an account list in a memory managed by itself for the received account information (in 808 of FIG. 8). The account list refers to a list that contains information of accounts that can provide a print content via the printer management server 803 to the printer 802 and cause the printer 802 to execute printing of the print content. After the search, if it is determined in 809 of FIG. 8 that the account information is included in the account list, the printer management server 803 registers the account information in a reception rejection list in the memory as account information from which reception and printing of a print content are to be rejected by the printer 802 (in 810 of FIG. 8). On the other hand, if it is determined in 809 of FIG. 8 that the account information is not included in the account list, the printer management server 803 notifies the printer 802 of this fact. Upon receipt of this notification, for example, the printer 802 displays this on the display device 104 to notify the user that the account information cannot be registered in the reception rejection list.

Note that account information of a source from which reception and printing of a print content are to be permitted by the printer 802 can be registered in the same process as that illustrated in FIG. 8.

When the user of the printer 802 has deleted registered account information on the screen of FIG. 5 by using the input device 103, the printer management server 803 is notified of this deletion. Upon receipt of this notification, the printer management server 803 deletes, from the account list, the corresponding account registered for rejection (or permission) of reception and printing therefrom. Note that although, in this example, a portal server 804 is not notified of account information from which printing is to be rejected, the portal server 804 may be notified of the account information. In this case, the portal server 804 may notify the user corresponding to the account information that the printing from the user is rejected.

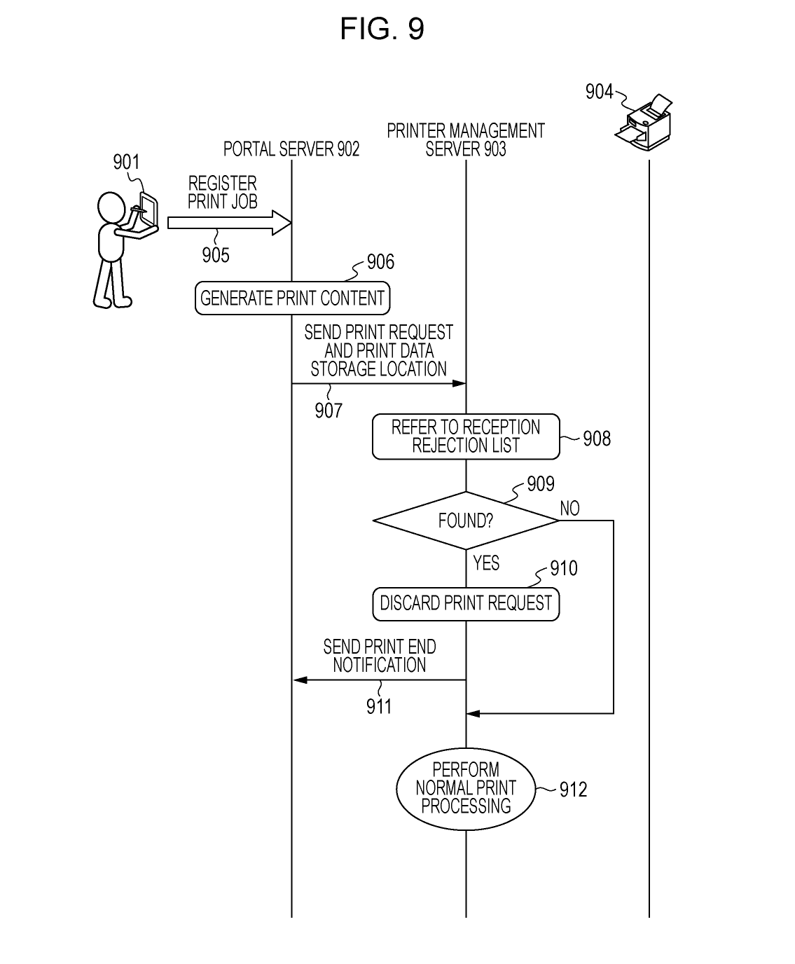

Next, a flow of processing will be described that is performed to prevent printing of a print content when the printing is from an account registered such that reception and printing of a print content therefrom are rejected (or when the printing is from any account other than an account registered such that reception and printing of a print content therefrom are permitted). FIG. 9 illustrates a flow of this process. Again, as in FIGS. 6 and 7, the flow to be described here is performed with the system configuration illustrated in FIG. 3.

Note that 901 to 907 in FIG. 9 are equivalent to 601 to 607 in FIG. 6 and will not be described here. Upon receipt of a print request in 907 of FIG. 9, the printer management server 903 refers to a reception rejection list in a memory managed by itself and determines whether there is account information corresponding to the print request (in 909 of FIG. 9). If it is determined that there is the account information, the printer management server 903 determines to reject printing based on the print request from the account information. In 910 of FIG. 9, the printer management server 903 discards the print request and information indicating a storage location of print data received in 907 of FIG. 9. Then, the printer management server 903 sends a print end notification to the portal server 902 (in 911 of FIG. 9). This improves efficiency, because this not only reduces printing of unnecessary print content, but also prevents the portal server 902 from retransmitting a print request and prevents a source user from having to re-register a print job. On the other hand, if it is determined in 909 of FIG. 9 that the account information described above is not present, the printer management server 903 determines to permit printing based on the print request from the account information. Then the process proceeds to 912, where normal print processing is performed as in 608 to 612 of FIG. 6, or in 713 to 717 and 708 to 712 of FIG. 7.

Thus, it is possible to prevent printing from a source from which the user wants to reject printing of a print content. This can be done easily, because this is done through operation in the printer 904, not by directly operating the portal server 902 or the printer management server 903.

In the example described above, the printer management server 903 determines whether to permit printing, and then rejects printing. Alternatively, this determination may be made by the printer 904. In this case, the CPU 109 of the printer 904 refers to the reception and printing rejection list 504 (see FIG. 5) stored in the storage device 107, determines whether to permit printing, and rejects reception and printing of a print content.

When the printer management server 903 makes a determination whether to permit printing, the printer management server 903 does not acquire any print content in the example described above. Alternatively, after acquiring print contents, the printer management server 903 may search for and delete, from the stored print contents, a print content from an account from which printing is to be rejected.

Instead of printing a cover page (such as that illustrated in FIG. 4) separately from a print content, the printer may print information that can identify an account within a printed material (e.g., at an end or on the backside of a page) where a print content is printed.

Although a printer having a scanning function has been described as an example of the print control apparatus in the foregoing description, the printer may be one that does not have a scanning function. In this case, information for identifying an account from which reception and printing of a print content are to be rejected is input from the input device 103. Like a printer and a printer management server, an interface apparatus connected between the printer and the printer management server and not having a printing function can perform processing similar to that performed by the print control apparatus.

When printing of a print content from account information designated by a printer management server is rejected, printing on a plurality of printers managed by the printer management server may be rejected, or only printing on a designated printer may be rejected.

Although printing in the print control apparatus is rejected as a consequence of rejecting reception of a print content in the foregoing description, reception may be permitted and only printing may be rejected.

### Other Embodiments

Additional embodiments can also be realized by a computer of a system or apparatus that reads out and executes computer executable instructions recorded on a storage medium (e.g., computer-readable storage medium) to perform the functions of one or more of the above-described embodiment(s), and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that these embodiments are not limiting. The scope of the following claims is to be accorded the broadest interpretation so as to encompass all such modifications and equivalent structures and functions.

This application claims the benefit of Japanese Patent Application No. 2012-203091 filed Sep. 14, 2012, which is hereby incorporated by reference herein in its entirety.

What is claimed is:

1. An apparatus comprising:
a receiving unit configured to receive information for identifying a requestor who has made a print request for printing a print content;
a notifying unit configured to provide notification of the requestor based on the information received by the receiving unit;
a designating unit configured to designate whether to permit the printing based on the print request from the requestor; and
a determining unit configured to determine whether to perform the printing based on the print request from the requestor in accordance with the designation made by the designating unit.

2. The apparatus according to claim 1, wherein the notifying unit provides notification of the requestor by printing the information received by the receiving unit on a recording medium.

3. The apparatus according to claim 2, wherein the designating unit designates whether to permit the printing based on the print request from the requestor by causing a reading device to read the information for identifying the requestor, wherein the information is printed on the recording medium.

4. The apparatus according to claim 1, wherein the designating unit designates whether to permit the printing based on the print request from the requestor when a user inputs information representing the requestor.

5. The apparatus according to claim 1, wherein when the designating unit designates that the printing based on the print request from the requestor is to be rejected, the determining unit determines not to perform the printing based on the print request from the requestor.

6. The apparatus according to claim 1, wherein when the designating unit designates that the printing based on the print request from the requestor is to be permitted, the determining unit determines to perform the printing based on the print request from the requestor and not to perform printing based on a print request from any source other than the requestor.

7. A method comprising:
receiving information for identifying a requestor who has made a print request for printing a print content;
providing notification of the requestor based on the received information;
designating whether to permit the printing based on the print request from the requestor; and
determining whether to perform the printing based on the print request from the requestor in accordance with the designation.

8. The method according to claim 7, wherein the notification is made by printing the received information on a recording medium.

9. The method according to claim 8, wherein the designation of whether to permit the printing based on the print request from the requestor is made by causing a reading device to read the information for identifying the requestor, wherein the information is printed on the recording medium.

10. The method according to claim 7, wherein the designation of whether to permit the printing based on the print request from the requestor is made when a user inputs information representing the requestor.

11. The method according to claim 7, wherein when the printing based on the print request from the requestor is designated to be rejected, the printing based on the print request from the requestor is determined not to be performed.

12. The method according to claim 7, wherein when the printing based on the print request from the requestor is designated to be permitted, the printing based on the print request from the requestor is determined to be performed and printing based on a print request from any source other than the requestor is determined not to be performed.

13. A computer-readable storage medium that stores computer-executable instructions for causing a computer to execute the method according to claim 7.
